(19) United States
(12) Patent Application Publication
(10) Pub. No.: US 2013/0325603 A1
(43) Pub. Date: Dec. 5, 2013

(54) PROVIDING ONLINE CONTENT

(71) Applicants: Gil Shamir, Sewickley, PA (US); Amit Prakash, Belmont, CA (US); Xinlong Bao, Gibsonia, PA (US); Ke Huang, Sunnyvale, CA (US); Shankar Ponnekanti, Mountainview, CA (US)

(72) Inventors: Gil Shamir, Sewickley, PA (US); Amit Prakash, Belmont, CA (US); Xinlong Bao, Gibsonia, PA (US); Ke Huang, Sunnyvale, CA (US); Shankar Ponnekanti, Mountainview, CA (US)

(73) Assignee: Google Inc.

(21) Appl. No.: 13/486,900

(22) Filed: Jun. 1, 2012

(51) Int. Cl. G06Q 30/02

(52) U.S. Cl. 705/14.52

(57) ABSTRACT

Systems and methods for providing online content include determining the likelihood of an online event occurring regarding the content. A likelihood value may be generated by analyzing history data indicative of one or more online events to identify content presentations and content interactions. Content presentations and content interactions may be grouped by topical category, in some implementations.

### BACKGROUND

The present disclosure relates generally to providing online content. The present disclosure more specifically relates to dynamically providing content based on its potential relevance to a user.

Online content may be available regarding any number of disparate topics. For example, a first website on the Internet may be devoted to the migratory habits of barn swallows and a second website may be devoted to automotive repair. In many cases, a user must proactively seek out online content of interest to the user. For example, an Internet user may utilize a search engine to search for webpages devoted to automotive repair. The user may then navigate between the webpages in the search results until the user finds the webpage that most closely matches the user's interests. To help simplify a user's browsing experience regarding a return visit to a webpage of interest, many web browsers now include the ability to bookmark webpages. For example, a user may bookmark a webpage devoted to replacing a valve cover gasket in an engine for later review. The user can then select the bookmark to go directly to the webpage, instead of having to repeat the search for the corresponding webpage of interest.

### SUMMARY

Implementations of the systems and methods for providing online content are described herein. One implementation is a computerized method for providing online content. The method includes receiving, at a processing circuit, history data associated with a client identifier, the history data being indicative of one or more online events. The method also includes analyzing the history data to determine a number of times content regarding a category of subject matter was presented at a computing device corresponding to the client identifier. The method further includes analyzing the history data to determine a number of times the content regarding the category of subject matter was clicked at the computing device. The method additionally includes determining, by the processing circuit, a likelihood value that is based in part on the number of times the content was presented and is based in part on the number of times the content was clicked, the likelihood value representing a likelihood of a user of the computing device performing an action in response to being presented with an advertisement related to the category of the subject matter. The method further includes providing the advertisement for display at the computing device based in part on the likelihood value.

Another implementation is a system for providing online content. The system includes a processing circuit operable to receive history data associated with a client identifier, the history data being indicative of one or more online events. The processing circuit is also operable to analyze the history data to determine a number of times content regarding a category of subject matter was presented at a computing device corresponding to the client identifier. The processing circuit is additionally operable to analyze the history data to determine a number of times the content regarding the category of subject matter was clicked at the computing device. The processing circuit is further operable to determine a likelihood value that is based in part on the number of times the content was presented and is based in part on the number of times the content was clicked, the likelihood value representing a likelihood of a user of the computing device performing an action in response to being presented with an advertisement related to the category of the subject matter. The processing circuit is also operable to provide the advertisement for display at the computing device based in part on the likelihood value.

A further implementation is computer-readable storage medium having machine instructions stored therein, the instructions being executable by a processor to cause the processor to perform operations. The operations include receiving history data associated with a client identifier, the history data being indicative of one or more online events. The operations also include analyzing the history data to determine a number of times content regarding a category of subject matter was presented at a computing device corresponding to the client identifier. The operations further include analyzing the history data to determine a number of times the content regarding the category of subject matter was clicked at the computing device. The operations additionally include determining a likelihood value that is based in part on the number of times the content was presented and is based in part on the number of times the content was clicked, the likelihood value representing a likelihood of a user of the computing device performing an action in response to being presented with an advertisement related to the category of the subject matter. The operations yet further include providing the advertisement for display at the computing device based in part on the likelihood value.

These implementations are mentioned not to limit or define the scope of this disclosure, but to provide examples of implementations to aid in understanding thereof.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system in accordance with a described implementation;

FIG. 2 is an illustration of an electronic display showing an example webpage;

FIG. 3 is an example illustration of content being included with a webpage by a content selection server; and

FIG. 4 is an example flow diagram of a process for providing online content.

Like reference numbers and designations in the various drawings indicate like elements.

### DETAILED DESCRIPTION

According to some aspects of the present disclosure, online content may be dynamically selected for a user based the user's potential interest in the content. Thus, a user may be provided content of interest without the user having to proactively locate the content. In some implementations, a user may opt in to allowing a content selection service to analyze history data indicative of online actions performed by the user. Such a service may be configured to select content of relevance to the user by identifying online actions performed by the user. For example, which types of content were requested by the user and how the user interacted with the content may be analyzed to determine potential interests of the user. In some implementations, the user's interactions with content selected by the content selection service may be analyzed to predict whether the user will be interested in other content. In other words, the user's reaction to content selected by the service may be used as feedback to adjust how the service selects content for the user.

A user may opt in or out of allowing a content selection service to store and use data regarding online actions performed by the user. Moreover, the user may be represented in the service as a randomized user identifier (e.g., a cookie, a device serial number, etc.) that contains no personally-identifiable information about the user. For example, information relating to the user's name and/or demographics (e.g., the user's education level, profession, age, gender, race, marital status, income, etc.), may not be used by the content selection service to select relevant content for the user, unless the user has opted in to allowing the service to use such information. A user identifier may be related to, or may itself be, a client identifier that identifies the user's device to the content selection service (e.g., a cookie set on the device, an IP address of the device, etc.). In some implementations, a user identifier may be associated with multiple client identifiers. For example, a user identifier may be associated with a client identifier for the user's mobile telephone and a second client identifier for the user's home computer.

A content selection service may provide selected content in conjunction with other online content requested by a user. For example, a content selection service may relate a user identifier with an interest category of golf. Such an interest category may then be used by the content selection service to provide golf-related content to a device associated with the user identifier, when the device requests a webpage. In some implementations, content selected by the content selection service may be interactive (e.g., a playable video or audio file, a hotlinked image that redirects the user's browser to another webpage, etc.). In such a case, interactive content may be used to suggest additional content for review by the user. For example, a content selection service may select an image of a fisherman that is hotlinked to a webpage devoted to reviews of fishing equipment. If the user wishes to receive additional content related to fishing, the user may then click on the image. In some implementations, a topic of content selected by the content selection service may not be related to the topic of the webpage being visited by the user. For example, a user interested in fishing may be presented with a hotlinked image relating to fishing while visiting a webpage devoted to cooking recipes. If the user wishes to see more content related to fishing, he may click on the hotlinked image to be redirected to a fishing-related webpage.

In various implementations, a content selection service may calculate a value representing the likelihood of an event occurring regarding presented content. In some cases, an online event may correspond to one or more actions performed by the user in response to being presented certain content. For example, an online event may correspond to searching for a particular topic, navigating to a webpage having that topic, following a hotlink of content selected by the service (e.g., by clicking or otherwise selecting the content via a user interface, such as a mouse or touch screen display), the user performing an action on a hotlinked webpage (e.g., downloading an application, making a purchase of a good or service, etc.), and the user performing a search for additional information regarding content selected by the service. The content selection service may analyze history data indicative of one or more previous online events to calculate a likelihood value.

A content selection service may use a calculated likelihood value to select and provide content. For example, webpages visited by a user and/or searches conducted by the user may be analyzed by the service to determine one or more interests of the user. In addition, the service may analyze online actions performed regarding content previously selected by the service. For example, assume that a user was identified as being interested in golf, based on a number of visits to golf-related webpages by the user. The content selection service may then select and provide golf-related content to a device of the user. The service may analyze how the user reacts to such content to determine the likelihood that the user will interact with future golf-related content. Thus, the content selection service may receive and analyze feedback after selecting content, to potentially adjust which content is provided to the user by the service.

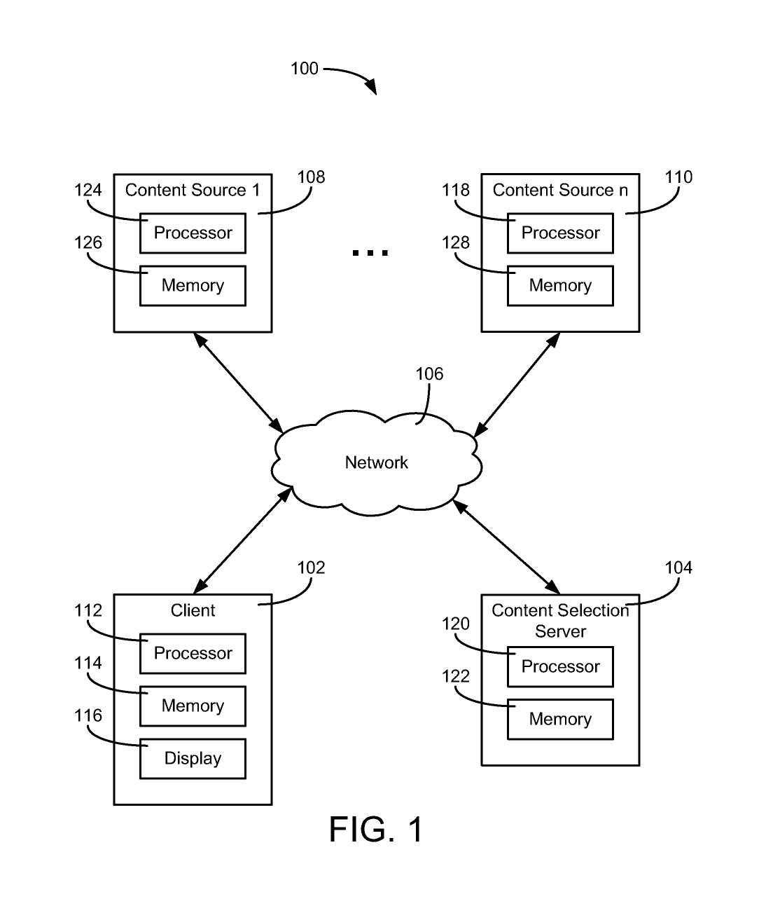

Referring to FIG. 1, a block diagram of a computer system 100 in accordance with a described implementation is shown. System 100 includes a client 102 which communicates with other computing devices via a network 106. Client 102 may execute a web browser or other application (e.g., a video game, a channel guide for streaming content, a media player, etc.) to retrieve content from other devices over network 106. For example, client 102 may communicate with any number of content sources 108, 110 (e.g., a first content source through nth content source). Content sources 108, 110 may provide webpage data and/or other content (e.g., text documents, PDF files, and other forms of electronic documents) to client 102. In some implementations, computer system 100 may also include a content selection server 104 configured to select content to be provided to client 102. For example, content source 108 may provide a webpage to client 102 that includes additional content selected by content selection server 104 based in part on the content's potential relevancy to the user of client 102.

Network 106 may be any form of computer network that relays information between client 102, content sources 108, 110, and content selection server 104. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client 102 may communicate wirelessly (e.g., via WiFi, cellular, radio, etc.) with a transceiver that is hardwired (e.g., via a fiber optic cable, a CAT5 cable, etc.) to other computing devices in network 106.

Client 102 may be any number of different types of user electronic devices configured to communicate via network 106 (e.g., a laptop computer, a desktop computer, a tablet computer, a smartphone, a digital video recorder, a set-top box for a television, a video game console, combinations thereof, etc.). Client 102 is shown to include a processor 112 and a memory 114, i.e., a processing circuit. Memory 114 may store machine instructions that, when executed by processor 112 cause processor 112 to perform one or more of the operations described herein. Processor 112 may include a microprocessor, ASIC, FPGA, etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ROM, RAM, EEPROM, EPROM, flash memory, optical media, or any other suitable memory from which processor 112 can read instructions. The instructions may include code from any suitable computer programming language such as, but not limited to, C, C++, C#, Java, JavaScript, Perl, HTML, XML, Python and Visual Basic.

Client 102 may include one or more user interface devices. A user interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to the housing of client 102 (e.g., a built-in display, microphone, etc.) or external to the housing of client 102 (e.g., a monitor connected to client 102, a speaker connected to client 102, etc.), according to various implementations. For example, client 102 may include an electronic display 116, which displays webpages and other data received from content sources 108, 110 and/or content selection server 104. In various implementations, electronic display 116 may be located inside or outside of the same housing as that of processor 112 and/or memory 114. For example, electronic display 116 may be an external display, such as a computer monitor, television set, or any other stand-alone form of electronic display. In other examples, electronic display 116 may be integrated into the housing of a laptop computer, mobile device, or other form of computing device having an integrated display.

Content sources 108, 110 may be one or more electronic devices connected to network 106 that provide content to client 102. For example, content sources 108, 110 may be computer servers (e.g., FTP servers, file sharing servers, web servers, etc.) or combinations of servers (e.g., data centers, cloud computing platforms, etc.). Content may include, but is not limited to, webpage data, a text file, a spreadsheet, images, search results, and other forms of electronic documents. Similar to client 102, content sources 108, 110 may include processing circuits comprising processors 124, 118 and memories 126, 128, respectively, that store program instructions executable by processors 124, 118. For example, the processing circuit of content source 108 may include instructions such as web server software, FTP serving software, and other types of software that cause content source 108 to provide content via network 106.

According to various implementations, content sources 108, 110 may provide webpage data to client 102 that includes one or more content tags. In general, a content tag may be any piece of webpage code associated with the action of including content with a webpage. According to various implementations, a content tag may define a slot on a webpage for additional content, a slot for out of page content (e.g., an interstitial slot), whether content should be loaded asynchronously or synchronously, whether the loading of content should be disabled on the webpage, whether content that loaded unsuccessfully should be refreshed, the network location of a content source that provides the content (e.g., content sources 108, 110, content selection server 104, etc.), a network location (e.g., a URL) associated with clicking on the content, how the content is to be rendered on a display, one or more keywords used to retrieve the content, and other functions associated with providing additional content with a webpage. For example, content source 108 may provide webpage data that causes client 102 to retrieve content from content selection server 104. In another implementation, content may be selected by content selection server 104 and provided by content source 108 as part of the webpage data sent to client 102.

Similar to content sources 108, 110, content selection server 104 may be one or more electronic devices connected to network 106 that selects content to be provided to client 102 based on a predicted relevancy to the user of client 102. Content selection server 104 may be a computer server (e.g., FTP servers, file sharing servers, web servers, etc.) or a combination of servers (e.g., a data center, a cloud computing platform, etc.). Content selection server 104 may include a processing circuit including a processor 120 and a memory 122 that stores program instructions executable by processor 120. In cases in which content selection server 104 is a combination of computing devices, processor 120 may represent the collective processors of the devices and memory 122 may represent the collective memories of the devices. The processing circuit of content selection server 104 may be configured to conduct an auction to select content to be provided to client 102. For example, content selection server 104 may select content, such as an advertisement, to be provided with a webpage served by content source 108 or 110.

In some implementations, content selection server 104 may be configured to select content based on a user identifier associated with client 102. In general, a user identifier refers to any form of data that may be used to represent a user that has opted in to receiving content selected by content selection server 104. In some implementations, a user identifier may be associated with a client identifier that identifies a client device to content selection server 104 or may itself be the client identifier. In some implementations, a user identifier may be associated with multiple client identifiers (e.g., a client identifier for a mobile device, a client identifier for a home computer, etc.). Client identifiers may include, but are not limited to, cookies, device serial numbers, user profile data, telephone numbers, or network addresses. For example, a cookie set on client 102 may be used to identify client 102 to content selection server 104.

Content selection server 104 may use information associated with a user identifier to select relevant content for the represented user, if the user has opted in to the functionality of content selection server 104. For example, content selection server 104 may analyze history data associated with a user identifier to determine one or more potential interest categories for the user identifier. History data may be any data associated with a user identifier that is indicative of an online event (e.g., visiting a webpage, interacting with presented content, conducting a search, making a purchase, downloading content, etc.). Content selection server 104 may select content to be provided in conjunction with other content by client 102 (e.g., as part of a displayed webpage, as a pop-up, within a video game, within another type of application, etc.).

In various implementations, content selection server 104 may receive history data indicative of one or more online events associated with a user identifier. In implementations in which a content tag causes client 102 to request content from content selection server 104, such a request may include a client identifier for client 102 and/or additional information (e.g., the webpage being loaded, the referring webpage, etc.). Content selection server 104 may store such data to record a history of online events associated with a user identifier. In some cases, client 102 may provide history data to content selection server 104 without first executing a content tag. For example, client 102 may periodically send history data to content selection server 104 or may do so in response to receiving a command from a user interface device. In some implementations, content selection server 104 may receive history data from content sources 108, 110. For example, content source 108 may store history data regarding web transactions with client 102 and provide the history data to content selection server 104.

Content selection server 104 may generate a likelihood value by analyzing history data for a user identifier. In various implementations, the likelihood value may represent the likelihood of an online event occurring, should certain content be provided to a device associated with the user identifier. For example, the likelihood value may represent the likelihood that the user of client 102 will click on a content selected by content selection server 104. In some implementations, the likelihood value may be a probability of the online event occurring. For example, a likelihood value of 0.30 may represent a 30% chance that a user will click on an image selected by content selection server 104. In various implementations, identified characteristics of the history data may be used with a machine learning model to generate the likelihood value. For example, a Bayesian network, neural network, regression model, logistics regression model, or similar form of machine learning model may be used to generate a likelihood value. In other implementations, a value indicative of how unlikely an event is to occur may be used instead of a likelihood value (e.g., there may be a 70% chance that a user will not click on an image selected by content selection server 104).

A likelihood value may be generated based in part on one or more identified interest categories for a user identifier (e.g., a theme or topic of received content). In some cases, content selection server 104 may analyze history data for the user identifier to identify one or more interest categories and online events relating to the interest categories. For example, a user interested in philately may perform a number of searches for “stamps,” “stamp collecting,” and “stamp preservation.” In such a case, history data associated with the user's identifier may be analyzed by content selection server 104 to identify philately as a potential interest category. Content selection server 104 may also identify the strength of the interest, in some cases. For example, ten visits per day to philately-related webpages may indicate a stronger interest than only two visits per day. Thus, a user having a strong interest in philately may have a higher likelihood of selecting a hotlinked image of a stamp than a user that has only a weak interest in the hobby.

A likelihood value may also be generated based in part on one or more online events indicated by the history data. For example, content selection server 104 may identify the number of times content was selected by content selection server 104 and provided to a device associated with a particular user identifier. In some cases, the number of times the content was presented may be subdivided by a theme, topic, category, etc., of the content. For example, content selection server 104 may analyze the history data to identify that golf-related content was provided five times to client 102. Content selection server 104 may also analyze the history data to identify the number of times a particular online event occurred regarding an identified topic (i.e., by analyzing how the user responds to certain topics). In some implementations, content selection server 104 may analyze the history data to identify content interactions. For example, content selection server 104 may analyze the history data to determine that the user of client 102 clicked on the golf-related content selected by content selection server 104 twice out of the five times that the content was presented. Such a metric may be used as part of the machine learning model to predict the likelihood of a certain event occurring, should additional golf-related content be selected by content selection server 104 for client 102.

In various implementations, content selection server 104 may be configured to allow different content providers to compete for the ability to have content selection server 104 select their content. For example, an online retailer may utilize content selection server 104 to place an advertisement on a webpage served by content source 108. In another example, a non-profit organization may utilize content selection server 104 to place a public service announcement within an application running on client 102 (e.g., within a running video game). Competition may be based, for example, among content providers that provide content having a topic that matches an interest category identified for a user identifier. For example, online retailers of tennis rackets may compete for the ability to provide an advertisement based on a user identifier being associated with the interest category of tennis.

In some implementations, content selection server 104 may be configured to conduct an auction to select from which content provider the content is to be provided. In some cases, content providers wishing to provide content to certain users may place bids in an auction. The auction may be conducted by content selection server 104 in real-time (e.g., in response to receiving a content selection request from client 102), or beforehand. In some implementations, content selection server 104 may automatically select the participants for the auction and/or determine bids for the participants. For example, assume that a user identifier is associated with the interest categories of golf, philately, and skydiving. In response to receiving a content selection request, content selection server 104 may select auction participants among those content providers that identified golf, philately, or skydiving as a topic of their content. Content selection server 104 may also use one or more determined likelihood values to determine a bid for an auction participant. For example, content selection server 104 may generate a bid on behalf of an advertiser of golf clubs based in part on the likelihood that the user receiving the advertisement will click on the advertisement and/or make a purchase on the advertiser's website. Thus, bids may differ for users having equal interests in a topic, based on the likelihood that a user will interact with the selected content.

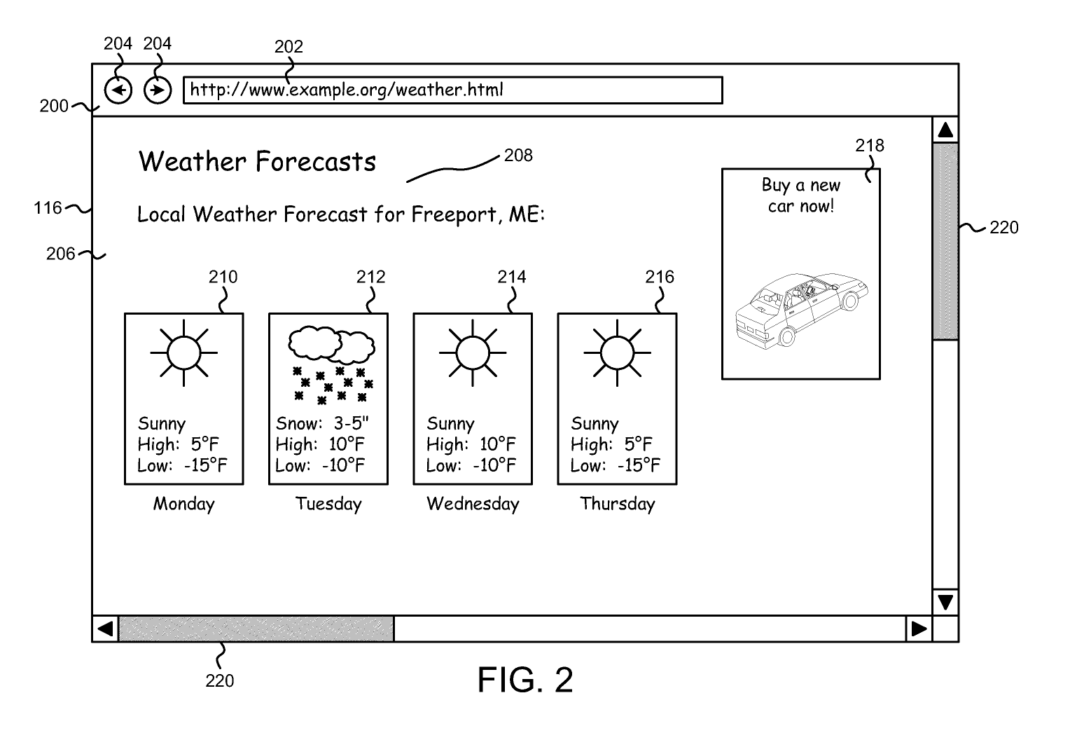

Referring now to FIG. 2, an illustration is shown of electronic display 116 displaying an example webpage 206. Electronic display 116 is in electronic communication with processor 112 which causes visual indicia to be displayed on electronic display 116. As shown, processor 112 may execute a web browser 200 stored in memory 114 of client 102, to display indicia of content received by client 102 via network 106. In other implementations, another application executed by client 102 may incorporate some or all of the functionality described with regard to web browser 200 (e.g., a video game, a chat application, etc.).

Web browser 200 may operate by receiving input of a universal resource locator (URL) via a field 202 from an input device (e.g., a pointing device, a keyboard, a touch screen, etc.). For example, the URL, http://www.example.org/weather.html, may be entered into field 202. Processor 112 may use the inputted URL to request data from a content source having a network address that corresponds to the entered URL. In response to the request, the content source may return webpage data and/or other data to client 102. Web browser 200 may analyze the returned data and cause visual indicia to be displayed by electronic display 116 based on the data.

In general, webpage data may include text, hyperlinks, layout information, and other data that may be used to provide the framework for the visual layout of webpage 206. In some implementations, webpage data may be one or more files of webpage code written in a markup language, such as the hypertext markup language (HTML), extensible HTML (XHTML), extensible markup language (XML), or any other markup language. For example, the webpage data in FIG. 2 may include a file, “weather.html” provided by the website, “www.example.org.” The webpage data may include data that specifies where indicia appear on webpage 206, such as text 208. In some implementations, the webpage data may also include additional URL information used by web browser 200 to retrieve additional indicia displayed on webpage 206. For example, the file, “weather.html,” may also include one or more instructions used by processor 112 to retrieve images 210-216 from their respective content sources.

Web browser 200 may include a number of navigational controls associated with webpage 206. For example, web browser 200 may be configured to navigate forward and backwards between webpages in response to receiving commands via inputs 204 (e.g., a back button, a forward button, etc.). Web browser 200 may also include one or more scroll bars 220, which can be used to display parts of webpage 206 that are currently off-screen. For example, webpage 206 may be formatted to be larger than the screen of electronic display 116. In such a case, the one or more scroll bars 220 may be used to change the vertical and/or horizontal position of webpage 206 on electronic display 116.

Webpage 206 may be devoted to one or more topics. For example, webpage 206 may be devoted to the local weather forecast for Freeport, Me. In some implementations, a content selection server, such as content selection server 104, may analyze the contents of webpage 206 to identify one or more topics. For example, content selection server 104 may analyze text 208 and/or images 210-216 to identify webpage 206 as being devoted to weather forecasts. In some implementations, webpage data for webpage 206 may include metadata that identifies a topic.

In various implementations, content selection server 104 may select some or all of the content presented on webpage 206. For example, content selection server 104 may select advertisement 218 to be included on webpage 206, based on a user identifier associated with client 102. In some implementations, one or more content tags may be embedded into the code of webpage 206 that defines a content field located at the position of advertisement 218. Another content tag may cause web browser 200 to request additional content from content selection server 104, when webpage 206 is loaded. Such a request may include one or more keywords, a client identifier for client 102, or other data used by content selection server 104 to select content to be provided to client 102. In response, content selection server 104 may select advertisement 218.

Advertisement 218 may be selected based in part on an interest category identified by analyzing history data associated with a client identifier for client 102. For example, assume that the user of web browser 200 researched various makes and models of automobiles. Data regarding the research may be analyzed by content selection server 104 to identify automobiles as a potential interest category. Advertisers for automobiles may then compete in an auction to determine which advertiser is able to provide an advertisement to client 102. Thus, advertisement 218 may be provided on webpage 206 based on a potential interest of the user of client 102 (e.g., automobiles), without regard to the actual topic of webpage 206 (e.g., a weather forecast).

In some implementations, advertisement 218 may also be selected based in part on one or more likelihood values generated by analyzing history data. For example, advertisement 218 may be selected based on a likelihood value indicative of the likelihood that the user of client 102 will click on advertisement 218 and/or make a purchase from the advertiser. In implementations in which an auction is conducted by content selection server 104, the one or more likelihood values may be used to generate bids on behalf of auction participants. For example, assume that a likelihood value indicates a high likelihood that the user of client 102 will click on advertisement 218 (e.g., to be redirected to the advertiser's website). In such a case, the bid generated on behalf of the advertiser may be generated such that the advertiser is the winner of the auction and advertisement 218 is selected by content selection server 104.

In some implementations, content selection server 104 may provide advertisement 218 directly to client 102. In other implementations, content selection server 104 may send a command to client 102 that causes client 102 to retrieve advertisement 218. For example, the command may cause client 102 to retrieve advertisement 218 from a local memory, if advertisement 218 is already stored in memory 114, or from a networked content source. In this way, any number of different pieces of content may be placed in the location of advertisement 218 on webpage 206. In other words, one user that visits webpage 206 may be presented with advertisement 218 and a second user that visits webpage 206 may be presented with different content. Other forms of content (e.g., an image, text, an audio file, a video file, etc.) may be selected by content selection server 104 for display with webpage 206 in a manner similar to that of advertisement 218. In further implementations, content selected by content selection server 104 may be displayed outside of webpage 206. For example, content selected by content selection server 104 may be displayed in a separate window or tab of web browser 200, may be presented via another software application (e.g., a text editor, a media player, etc.), or may be downloaded to client 102 for later use.

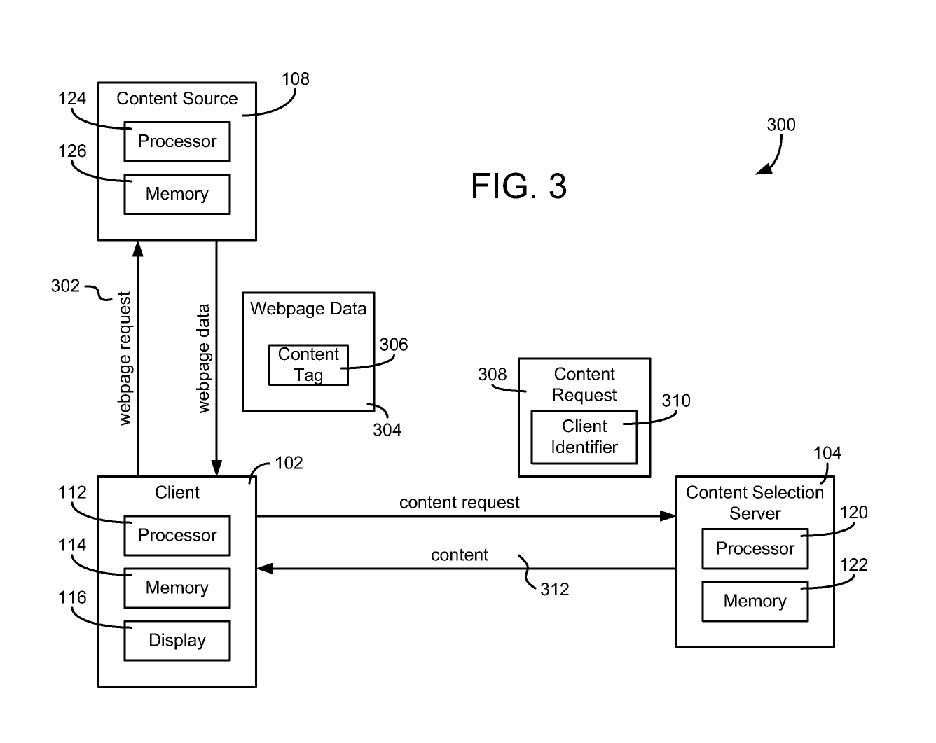

FIG. 3 is an example illustration of content 312 being selected by content selection server 104. As shown, client 102 may send a webpage request 302 to a content source via network 106, such as content source 108. For example, webpage request 302 may be a request that conforms to the hypertext transfer protocol (HTTP), such as the following:

GET /weather.html HTTP/1.1
Host: www.example.org

Such a request may include the name of the file to be retrieved, weather.html, as well as the network location of the file, www.example.org. In some cases, a network location may be an IP address or may be a domain name that resolves to an IP address of content source 108. In some implementations, a client identifier, such as a cookie associated with content source 108, may be included with webpage request 302 to identify client 102 to content source 108.

In response to receiving webpage request 302, content source 108 may return webpage data 304, such as the requested file, “weather.html.” Webpage data 304 may be configured to cause client 102 to display a webpage on electronic display 116 when opened by a web browser application. In some cases, webpage data 304 may include code that causes client 102 to request additional files to be used as part of the displayed webpage. For example, webpage data 304 may include an HTML image tag of the form:

<img src=“Monday_forecast.jpg”>

Such code may cause client 102 to request the image file “Monday_forecast.jpg,” from content source 108.

In some implementations, webpage data 304 may include content tag 306 configured to cause client 102 to retrieve an advertisement from content selection server 104. In some cases, content tag 306 may be an HTML image tag that includes the network location of content selection server 104. In other cases, content tag 306 may be implemented using a client-side scripting language, such as JavaScript. For example, content tag 306 may be of the form:

<script type= ‘text/javascript’>
AdNetwork_RetrieveAd(“argument”)
</script>

where AdNetwork RetrieveAd is a script function that causes client 102 to send a content request 308 to content selection server 104. In various implementations, the argument of the script function may include the network address of content selection server 104, the referring webpage, and/or additional information that may be used by content selection server 104 to select content to be included with the webpage.

Content request 308 may include a client identifier 310, used by content selection server 104 to identify client 102. In various implementations, client identifier 310 may be an HTTP cookie previously set by content selection server 104 on client 102, the IP address of client 102, a unique device serial for client 102, other forms of identification information, or combinations thereof. For example, content selection server 104 may set a cookie that includes a unique string of characters on client 102 when content is first requested by client 102 from content selection server 104. Such a cookie may be included in subsequent content requests sent to content selection server 104 by client 102.

In some implementations, client identifier 310 may be used by content selection server 104 to store history data for client 102, with the permission of the user of client 102. For example, content request 308 may include data relating to which webpage was requested by client 102, when the webpage was requested, and/or other history data. Whenever client 102 visits a webpage that allows content selection server 104 to select content to appear in conjunction with the webpage, content selection server 104 may receive and store history data for client 102. In this way, content selection server 104 is able to reconstruct the online history of client 102 regarding webpages that utilize content selection server 104. In some implementations, content selection server 104 may also receive history data for client 102 from content sources that do not use its content selection services. For example, a website that does not use content selected by content selection server 104 may nonetheless provide information about client 102 visiting the website to content selection server 104, if the user has opted in to receiving relevant content selected by content selection server 104.

In some cases, client identifier 310 may be sent to content selection server 104 when a particular online event occurs. For example, webpage data 304 may include a tag that causes client 102 to send client identifier 310 to content selection server 104 when a displayed advertisement is clicked by the user of client 102. Client identifier 310 may also be used to record information after client 102 is redirected to another webpage. For example, client 102 may be redirected to an advertiser's website if the user selects a displayed advertisement. In such a case, client identifier 310 may also be used to record which actions were performed on the advertiser's website. For example, client identifier 310 may be sent to content selection server 104 as the user of client 102 navigates within the advertiser's website. In this way, data regarding whether the user searched for a product, added a product to a shopping cart, completed a purchase on the advertiser's website, etc., may also be recorded by content selection server 104.

Content selection server 104 may analyze history data associated with client identifier 310 to identify one or more interest categories and to model the behavior of the user of client 102. In various implementations content selection server 104 may utilize a machine learning model, such as a logistic regression model, to generate one or more likelihood values (e.g., the likelihood one or more events occurring). For example, content selection server 104 may generate a likelihood value indicative of the likelihood that the user of client 102 will click on a particular type of advertisement (e.g., a predicted click through rate), if selected by content selection server 104. In some implementations, content selection server 104 may conduct an auction in response to receiving content request 308. Bids in the auction may be based in part on a likelihood value, in some implementations. For example, a bid on behalf of an advertiser may be higher or lower based in part on how likely the user of client 102 is to interact with an advertisement from the advertiser. Content selection server 104 may use the results of the auction to select content 312 from the winner and provide content 312 to client 102.

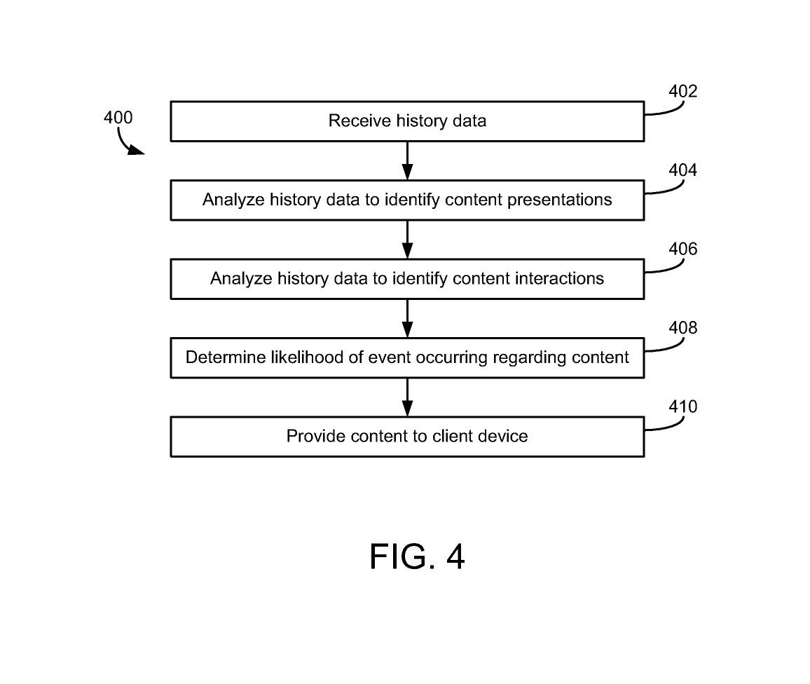

Referring now to FIG. 4, an illustration is shown of an example process 400 for providing online content. Process 400 may be implemented by one or more computing devices to select content that may be of interest to a user. For example, process 400 may be implemented by content selection server 104, shown in FIG. 1. In various implementations, a user may opt in to receiving content selected for the user via process 400. For example, a user may opt in to allowing history data to be stored regarding the user's online history (e.g., information regarding the websites visited by the user, whether the user interacted with certain content, etc.).

Process 400 includes receiving history data (block 402). In various implementations, the history data may be associated with a user identifier and/or a client identifier. For example, a cookie may be associated with the history data to represent a client device operated by a user. The history data may include, but is not limited to, event data indicative of events such as webpage visits (e.g., which webpages were visited, whether one webpage referred the client to another webpage, etc.), content interactions (e.g., how long a user reviewed a video or audio file, whether a user clicked on a displayed advertisement, etc.), and events regarding a retailer's webpage (e.g., whether the user searched for a good or service, whether the user completed a purchase, etc.). The history data may be received by a client device and/or by one or more content sources. For example, a client device may provide history data to a content selection server. In another example, a content source may provide the history data to the content selection server. In some implementations, the history data may be received from a local memory of the content selection server (i.e., the content selection server may retrieve stored history data from memory).

Process 400 includes analyzing the history data to identify content presentations (block 404). In general, content presentations refer to events corresponding to a client device presenting online content to a user. For example, a content presentation may correspond to a user being presented with a requested webpage devoted to the local webpage. In some implementations, content presentations may correspond to content selected by a content selection server. For example, the history data may be analyzed to identify the number of times an advertisement was provided to the client and/or the number of times an advertisement regarding a certain topic was presented by the client device. In some implementations, the content presentations may be grouped by topical category. For example, the history data may be analyzed to identify the number of times an advertisement for golf clubs was presented to the client device.

Process 400 includes analyzing the history data to identify content interactions (block 406). In general, content interactions refer to events corresponding to a user reacting to content presentations. Content interactions may include, but are not limited to, data indicative of the user performing a search in response to being presented content (e.g., the user is shown an advertisement for a new automobile and uses a search engine to find out more information about the advertised vehicle), clicking on presented content (e.g., playing a video or audio file, clicking on a displayed advertisement, etc.), or performing an action on a hotlinked webpage (e.g., adding a product to a shopping cart on an advertiser's website, making a purchase at the advertiser's website, etc.). Similar to content presentations, content interactions may be divided by topical categories, in some implementations. For example, the history data may be analyzed to determine how many times a presented advertisement for golf clubs was clicked by the user.

Process 400 includes determining the likelihood of an event occurring regarding content (block 408). In various implementations, a behavioral model may be constructed using the identified content presentations and content interactions. Such a behavioral model may be used to generate one or more likelihood values indicative of the likelihood of an event occurring. For example, previous content presentations and content interactions regarding golf-related advertisements may be analyzed to determine the likelihood of the user clicking on a future golf-related advertisement. In some cases, the likelihood value may correspond to a general event, such as the user interacting with any content selected by the content selection server. In some implementations, a behavioral model may be trained using history data for a plurality of other user identifiers. For example, how other users having similar interests interact with presented content may be analyzed to train such a model.

In some implementations, logistic regression may be used to generate a likelihood value. In general, a logistic regression function may be defined as follows:

$$f ( z ) = \frac{1}{1 + {e}^{- z}}$$

where f(z) represents the probability of an outcome, given a set of factors represented by z. The value of z may be determined as follows:

z=β₀+β₁x₁+β₂x₂+ . . . +βₖxₖ

where β₀ is the y-axis intercept, xᵢ is a characteristic affecting the probability outcome, and, βᵢ is a regression coefficient (e.g., how much xᵢ affects the outcome). According to some implementations, one or more values of xᵢ may be based on identified content presentations and content interactions for a user identifier. In some cases, xᵢ may correspond to the number of times a user interacted with content regarding a particular topic and βᵢ may correspond to a determined strength of the user's interest in the topic (e.g., based on the number of visits to webpages regarding the topic, based on a posted comment regarding the topic, based on a rating regarding the topic, etc.). Additional characteristics that may affect the probability outcome may include a topic of the content itself (e.g., one or more words in the content, an image in the content, etc.) and/or characteristics of the webpage with which the content is to be provided. For example, there may be a higher likelihood that a user interested in golf will click on a golf-related advertisement. However, the actual likelihood may vary, depending on the webpage with which the advertisement is provided (e.g., the user may be more likely to click on the advertisement if the webpage is also related to golf than if the webpage is unrelated to golf). Thus, some of the xᵢ values used in the logistic regression may relate to the content itself and/or the webpage with which the content is to be presented. In various implementations, f(z) may be used as a likelihood value or the likelihood value may be based on f(z). For example, the likelihood value may be the probability of a user clicking on a presented advertisement and making a purchase on the advertiser's website. In further implementations, other models may be used, such as naïve Bayesian, linear regression, etc., to generate a likelihood value indicative of an event occurring regarding content.

Process 400 includes providing content to a client device based in part on the determined likelihood value (block 410). Content may be selected according to various degrees of specificity regarding a particular topic and/or event. For example, a golf-related advertisement may be provided based on a user identifier being associated with the interest category of golf and having a high likelihood that the user will click on the advertisement. In another example, the golf-related advertisement may be provided based on the user identifier being associated with the interest category of sports. Similarly, the golf-related advertisement may be provided based on the likelihood that the user will click on any presented advertisement. In various implementations, an auction may be conducted to determine which content is to be provided. In such a case, the likelihood value may be used to generate one or more bids in the auction. For example, an advertiser may have a higher bid if the user is more likely to click on an advertisement and make a purchase.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

1. A method for providing online content comprising:
receiving, at a processing circuit, history data associated with a client identifier, the history data being indicative of one or more online events;
analyzing the history data to determine a number of times content regarding a category of subject matter was presented at a computing device corresponding to the client identifier;
analyzing the history data to determine a number of times the content regarding the category of subject matter was clicked at the computing device;
determining, by the processing circuit, a likelihood value that is based in part on the number of times the content was presented and is based in part on the number of times the content was clicked, the likelihood value representing a likelihood of a user of the computing device performing an action in response to being presented with an advertisement related to the category of the subject matter; and
providing the advertisement for display at the computing device based in part on the likelihood value.

2. The method of claim 1, wherein the action comprises clicking on the advertisement.

3. The method of claim 1, wherein the action comprises purchasing a good or service.

4. The method of claim 1 further comprising:
analyzing the history data to identify visits to one or more webpages regarding the topic; and
determining the likelihood value based in part on the visits to the one or more webpages regarding the topic.

5. The method of claim 1, further comprising:
determining a bid in an advertising auction based in part on the likelihood value and based in part on the category of the subject matter, wherein the bid corresponds to a request to provide the advertisement for display at the computing device; and
providing the advertisement for display at the computing device based on a determination that the bid is a winning bid in the advertising auction.

6. The method of claim 1, wherein the likelihood value is a determined probability of the user performing the action.

7. The method of claim 1, further comprising:
determining the likelihood value using a logistic regression model.

8. A system for providing online content comprising a processing circuit operable to:
receive history data associated with a client identifier, the history data being indicative of one or more online events;
analyze the history data to determine a number of times content regarding a category of subject matter was presented at a computing device corresponding to the client identifier;
analyze the history data to determine a number of times the content regarding the category of subject matter was clicked at the computing device;
determine a likelihood value that is based in part on the number of times the content was presented and is based in part on the number of times the content was clicked, the likelihood value representing a likelihood of a user of the computing device performing an action in response to being presented with an advertisement related to the category of the subject matter; and
provide the advertisement for display at the computing device based in part on the likelihood value.

9. The system of claim 8, wherein the action comprises clicking on the advertisement.

10. The system of claim 8, wherein the action comprises purchasing a good or service.

11. The system of claim 8, wherein the processing circuit is further operable to analyze the history data to identify visits to one or more webpages regarding the topic and to determine the likelihood value based in part on the visits to the one or more webpages regarding the topic.

12. The system of claim 8, wherein the processing circuit is further operable to determine a bid in an advertising auction based in part on the likelihood value and based in part on the category of the subject matter, wherein the bid corresponds to a request to provide the advertisement for display at the computing device, wherein the processing circuit is also operable to provide the advertisement for display at the computing device based on a determination that the bid is a winning bid in the advertising auction

13. The system of claim 8, wherein the likelihood value is a determined probability of the user performing the online action.

14. The system of claim 8, wherein the likelihood value is determined by the processing circuit using a logistic regression model.

15. A computer-readable storage medium having machine instructions stored therein, the instructions being executable by a processor to cause the processor to perform operations comprising:
receiving history data associated with a client identifier, the history data being indicative of one or more online events;
analyzing the history data to determine a number of times content regarding a category of subject matter was presented at a computing device corresponding to the client identifier;
analyzing the history data to determine a number of times the content regarding the category of subject matter was clicked at the computing device;
determining a likelihood value that is based in part on the number of times the content was presented and is based in part on the number of times the content was clicked, the likelihood value representing a likelihood of a user of the computing device performing an action in response to being presented with an advertisement related to the category of the subject matter; and
providing the advertisement for display at the computing device based in part on the likelihood value.

16. The storage medium of claim 15, wherein the action comprises clicking on the advertisement.

17. The storage medium of claim 15, wherein the action comprises purchasing a good or service.

18. The storage medium of claim 15, wherein the operations further comprise:
analyzing the history data to identify visits to one or more webpages regarding the topic; and
determining the likelihood value based in part on the visits to the one or more webpages regarding the topic.

19. The storage medium of claim 15, the operations further comprising:
determining a bid in an advertising auction based in part on the likelihood value and based in part on the category of the subject matter, wherein the bid corresponds to a request to provide the advertisement for display at the computing device; and
providing the advertisement for display at the computing device based on a determination that the bid is a winning bid in the advertising auction

20. The storage medium of claim 15, the operations further comprising:
determining the likelihood value using a logistic regression model.
